(19) United States
(12) Patent Application Publication
(10) Pub. No.: US 2019/0334238 A1
(43) Pub. Date: Oct. 31, 2019

(54) TRANSCEIVER AND ADJUSTING METHOD FOR PHASES IN TRANSCEIVER

(71) Applicant: FUJITSU LIMITED, Kawasaki-shi (JP)

(72) Inventor: Atsushi HONDA, Setagaya (JP)

(73) Assignee: FUJITSU LIMITED, Kawasaki-shi (JP)

(21) Appl. No.: 16/374,278

(22) Filed: Apr. 3, 2019

(30) Foreign Application Priority Data
Apr. 27, 2018 (JP) 2018-086175

(51) Int. Cl. H01Q 3/36; H01Q 3/42; H01Q 21/22; H04B 7/06; H04B 7/0408

(52) U.S. Cl. CPC H01Q 3/36; H01Q 3/42; H04B 7/0408; H04B 7/0682; H01Q 21/22

(57) ABSTRACT

A transceiver includes a plurality of first antenna elements, a first distributor that distributes a first data signal, a second distributor that distributes a carrier wave signal, a plurality of first phase shifters that shift phases of a plurality of the first data signals distributed by the first distributor, a plurality of second phase shifters that shift phases of a plurality of the carrier wave signals distributed by the second distributor, and a plurality of multipliers respectively connected to the plurality of first antenna elements, wherein outputs of the plurality of first phase shifters and outputs of the plurality of second phase shifters are respectively connected to the plurality of multipliers.

### CROSS-REFERENCE TO RELATED APPLICATION

This application is based upon and claims the benefit of priority of the prior Japanese Patent Application No. 2018-86175, filed on Apr. 27, 2018, the entire contents of which are incorporated herein by reference.

### FIELD

The embodiments discussed herein are related to a transceiver and an adjusting method for phases in the transceiver.

### BACKGROUND

There has been an automatic tracking antenna including a phased array antenna that adjusts phases of reception outputs of a plurality of antenna units respectively with phase shifting units and is capable of changing directions of multiplication beams of the antenna units respectively to an elevation angle direction and an azimuth angle direction.

The automatic tracking antenna further includes a scanning unit that controls the phase shifting unit to repeatedly direct the beams to an elevation angle different from an elevation angle of present beams in the elevation angle direction and direct the beams to an azimuth angle different from an azimuth angle of the present beams in the azimuth angle direction and a level detecting unit that detects a reception level of the phased array antenna.

The automatic tracking antenna further includes a determining unit that compares the reception levels at the different elevation angles and compares the reception levels at the different azimuth angles and controls, according to a result of the comparison, the phase shifting unit to direct the beams to the elevation angle and the azimuth angle at which the reception level is a maximum reception level in the elevation angle direction and a maximum reception level in the azimuth angle direction.

Phase shifters as many as the plurality of antenna units are respectively connected to the plurality of antenna units. A phase difference is adjusted by a plurality of phase shifters.

In a transceiver including the automatic tracking antenna in the past, phase shifters as many as the plurality of antenna units are respectively connected to the plurality of antenna units. The phase shifters have a relatively large circuit size and a complicated circuit configuration. A relatively large space is desirable to dispose the phase shifters. Therefore, a circuit size of the entire transceiver in the past is also large.

The following is a reference document.
[Document 1] Japanese Laid-open Patent Publication No. 09-138266.

### SUMMARY

According to an aspect of the embodiments, a transceiver includes a plurality of first antenna elements, a first distributor that distributes a first data signal, a second distributor that distributes a carrier wave signal, a plurality of first phase shifters that shift phases of a plurality of the first data signals distributed by the first distributor, a plurality of second phase shifters that shift phases of a plurality of the carrier wave signals distributed by the second distributor, and a plurality of multipliers respectively connected to the plurality of first antenna elements, wherein outputs of the plurality of first phase shifters and outputs of the plurality of second phase shifters are respectively connected to the plurality of multipliers.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a transceiver in a first embodiment;

FIG. 2 is a diagram illustrating the configuration of a connection switching unit;

FIG. 3 is a diagram illustrating a data structure of a phase difference database;

FIG. 4 is a flowchart illustrating processing executed by a control unit of a control device;

FIG. 5 is a diagram illustrating a simulation result of signal levels in a far field at the time when the transceiver irradiates a beam;

FIG. 6 is a diagram illustrating a transceiver in a second embodiment;

FIG. 7 is a diagram illustrating a transceiver in a modification of the second embodiment;

FIGS. 8A and 8B are a diagram illustrating a transceiver in a third embodiment;

FIG. 9 is a diagram illustrating a data structure of a phase difference database in the third embodiment; and

FIGS. 10A and 10B are a diagram illustrating a transceiver in a fourth embodiment.

### DESCRIPTION OF EMBODIMENTS

Hereinafter, embodiments applied to a transceiver and an adjusting method for phases in the transceiver are explained.

### First Embodiment

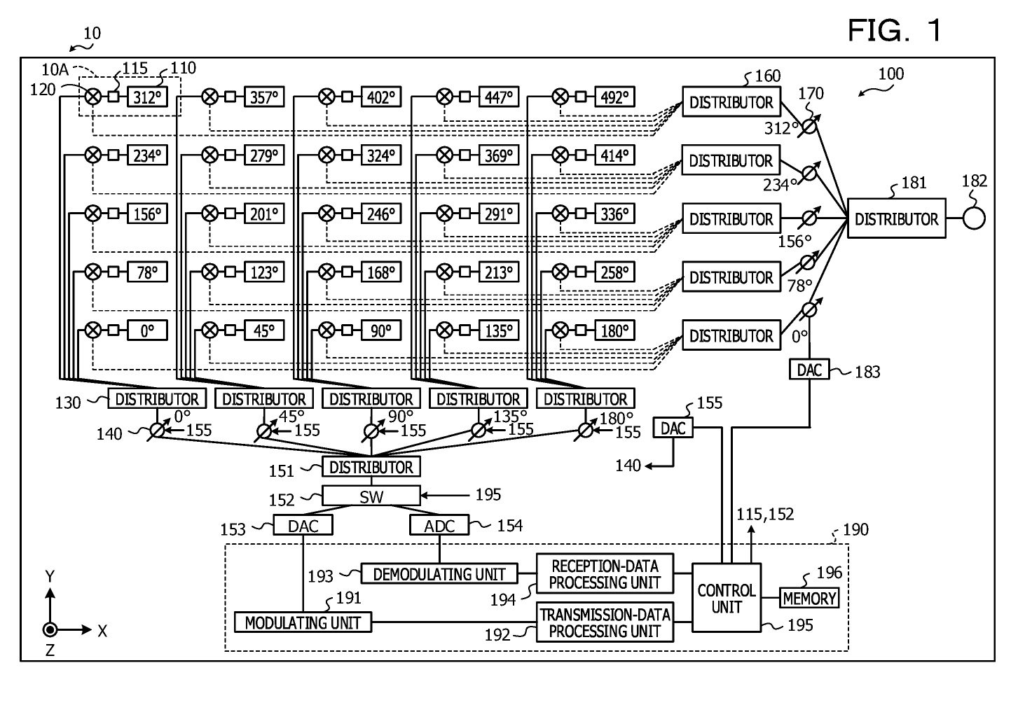

FIG. 1 is a diagram illustrating a transceiver 100 in a first embodiment. In the following explanation, an XYZ coordinate system is used for the explanation. In the following explanation, a plan view means an XY plane view.

The transceiver 100 includes a substrate 10, antenna elements 110, connection switching units 115, mixers 120, distributors 130, phase shifters 140, a distributor 151, a switch (SW) 152, a digital to analog converter (DAC) 153, an analog to digital converter (ADC) 154, and a DAC 155.

The transceiver 100 further includes distributors 160, phase shifters 170, a distributor 181, a local signal generator 182, a DAC 183, and a control device 190. As an example, the transceiver 100 is an apparatus used as a base station of a public line network used for communication with terminal machines such as a smartphone, a cellular phone, and a PC.

As an example, the substrate 10 is a multilayer substrate adapted to high speed transmission with a low loss. The multilayer substrate includes a plurality of insulating layers and a plurality of wiring layers. Since the transceiver 100 treats signals having frequencies of approximately several gigahertz to several ten gigahertz, the substrate 10 only has to be a substrate adapted to high speed transmission at such frequencies.

The antenna elements 110 are disposed on the surface on a Z-axis positive direction side of the substrate 10. The connection switching units 115, the mixers 120, the distributors 130, the phase shifters 140, the distributor 151, the switch 152, the DAC 153, the ADC 154, the DAC 155, the distributors 160, the phase shifters 170, the distributor 181, the local signal generator 182, the DAC 183, and the control device 190 are mounted on a surface on a Z-axis negative direction side of the substrate 10.

In FIG. 1, all the components are transparently indicated by solid lines in order to illustrate a positional relation among the components on a plane. In FIG. 1, wires for connection from the antenna elements 110 to the control device 190 are indicated by solid lines and broken lines. These wires pass through an inner layer of the substrate 10 and are connected via vias that pierce through the insulating layers of the substrate 10 in the thickness direction (a Z-axis direction).

The surface on the Z-axis positive direction side of the substrate 10 is an example of a first surface. The surface on the Z-axis negative direction side of the substrate 10 (the rear surface of the substrate 10) is an example of a second surface.

As an example, five antenna elements 110 are planarly (two-dimensionally) disposed in an X-axis direction (in five columns) and twenty-five antenna elements 110 are planarly (two-dimensionally) disposed in a Y-axis direction (in five rows). As an example, the antenna elements 110 are patch antennas having a rectangular shape in a plan view. The twenty-five antenna elements 110 are disposed at equal intervals along the X-axis direction and the Y-axis direction.

The length in the X-axis direction and the Y-axis direction of the antenna element 110 is ½ (λ/2) of an electric length λ of a wavelength in a communication frequency. An interval in the X-axis direction and the Y-axis direction between the antenna elements 110 adjacent to each other is ½ (λ/2) of the electric length λ of the wavelength in the communication frequency. For example, when the communication frequency is 28 gigahertz, both of the length in the X-axis direction and the Y-axis direction of the antenna element 110 and the interval in the X-axis direction and the Y-axis direction between the antenna elements 110 adjacent to each other are approximately 2 mm to 3 mm.

The antenna element 110 is an example of a first antenna element. The X-axis direction is an example of a first axial direction. The Y-axis direction is an example of a second axial direction. The X-axis direction is a row direction (a direction in which a row extends). The Y-axis direction is a column direction (a direction in which a column extends).

The mixers 120 are connected to the antenna elements 110 via the connection switching units 115. The phase shifters 140 are connected to the mixers 120 via the distributors 130. The phase shifters 170 are connected to the mixers 120 via the distributors 160. Wires connecting the mixers 120 and the distributors 160 are indicated by broken lines.

During transmission, the transceiver 100 gives distributions in the X-axis direction and the Y-axis direction to phases of radio waves radiated from the twenty-five antenna elements 110 to thereby adjust an azimuth angle and an elevation angle of one beam formed by multiplying together the radio waves radiated from the twenty-five antenna elements 110. The azimuth angle is an angle of the beam in an XZ plane. The elevation angle is an angle of the beam in a YZ plane.

During reception, in the same manner as during the transmission, the transceiver 100 adjusts a phase difference of radio waves received by the twenty-five antenna elements 110.

When such angles of the beam are adjusted, the twenty-five antenna elements 110 are divided into five groups for each of a plurality of rows extending in the X-axis direction and arrayed in the Y-axis direction (groups in the row direction) and five groups for each of a plurality of columns extending in the Y-axis direction and arrayed in the X-axis direction (groups in the column direction) to adjust the phase difference of the radio waves. The group in the column direction is an example of a first group. The group in the row direction is an example of a second group.

In FIG. 1, values of angles illustrated in the twenty-five antenna elements 110, five phase shifters 140, and five phase shifters 170 are values serving as examples in the case in which both of the azimuth angle and the elevation angle of the beam radiated by the transceiver 100 are set to 30°. When the azimuth angle and the elevation angle of the beam are adjusted to various angles, the values of these angles are adjusted to various values.

As an example, a phase of the antenna element 110 on a most negative direction side in the X-axis direction and on a most negative direction side in the Y-axis direction is set as a reference (0°). The phases of the radio waves radiated from the twenty-five antenna elements 110 are adjusted by the phase shifters 140 and 170.

As an example, when both of the azimuth angle and the elevation angle of the beam is set to 30°, the phase shifters 140 are adjusted to allocate phases of 0°, 45°, 90°, 135°, and 180° to the five antenna elements 110 included in a group in the row direction on the most negative direction side in the Y-axis direction (a group in a first row). A phase difference is 45°.

Such a phase difference of 45° is the same in the five antenna elements 110 included in each of a second group in the row direction (a group in a second row), a third group in the row direction (a group in a third row), a fourth group in the row direction (a group in a fourth row), and a fifth group in the row direction (a group in a fifth row) from the most negative direction side in the Y-axis direction.

As an example, when both of the azimuth angle and the elevation angle of the beam is set to 30°, the phase shifters 170 are adjusted to allocate phases of 0°, 78°, 156°, 234°, and 312° to the five antenna elements 110 included in a group in the column direction on the most negative direction side in the X-axis direction (a group in a first column). A phase difference is 78°.

Such a phase difference of 78° is the same in the five antenna elements 110 included in each of a second group in the column direction (a group in a second column), a third group in the column direction (a group in a third column), a fourth group in the column direction (a group in a fourth column), and a fifth group in the column direction (a group in a fifth column) from the most negative direction side in the X-axis direction.

In this way, as an example, the phase difference of 45° is set in the X-axis direction by the phase shifters 140 and the phase difference of 78° is set in the Y-axis direction by the phase shifters 170, whereby phase differences may be allocated to the twenty-five antenna elements 110 as illustrated in FIG. 1. In this case, phase differences of 0°, 45°, 90°, 135°, 180°, 78°, 123°, 168°, 213°, 258°, 156°, 201°, 246°, 291°, 336°, 234°, 279°, 324°, 369°, 414°, 312°, 357°, 402°, 447°, and 492° may be allocated to the twenty-five antenna elements 110.

Such allocation of the phase differences is realized by adjusting phases set in the phase shifters 140 and 170. As an example, when both of the azimuth angle and the elevation angle are set to 30°, as illustrated in FIG. 1, 0°, 45°, 90°, 135°, and 180° are respectively allocated to the five phase shifters 140 and 0°, 78°, 156°, 234°, and 312° are respectively allocated to the five phase shifters 170.

When values of the azimuth angle and the elevation angle are set to other values, the phases set in the phase shifters 140 and 170 only have to be set to values different from the phases described above. By adjusting the values of the phases set in the phase shifters 140 and 170, it is possible to adjust the azimuth angle and the elevation angle of the beam radiated by the transceiver 100.

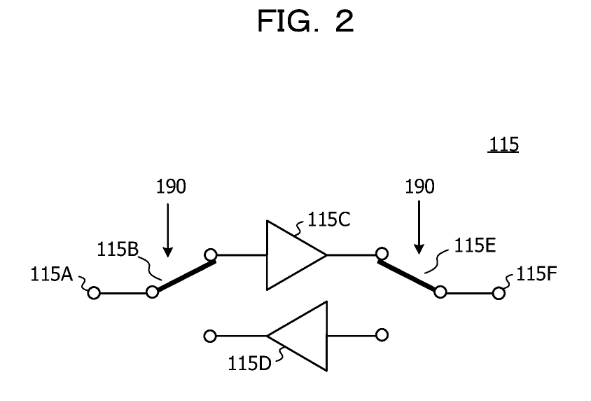

Twenty-five connection switching units 115 are installed corresponding to the twenty-five antenna elements 110. The connection switching units 115 are explained with reference to FIG. 2 in addition to FIG. 1. FIG. 2 is a diagram illustrating the configuration of the connection switching unit 115.

As illustrated in FIG. 1, one terminal of the connection switching unit 115 is connected to the mixer 120. The other terminal of the connection switching unit 115 is connected to a power feeding point of the antenna element 110.

As illustrated in FIG. 2, the connection switching unit 115 includes a terminal 115A, a switch 115B, a power amplifier (PA) 115C, a low noise amplifier (LNA) 115D, a switch 115E, and a terminal 115F. As an example, such a connection switching unit 115 may be realized as one chip component.

The terminal 115A is connected to the mixer 120. The terminal 115F is connected to the power feeding point of the antenna element 110. Switching control is performed on the switches 115B and 115E by the control device 190. The switches 115B and 115E connect the PA 115C between the terminal 115A and the terminal 115F during the transmission and connect the LNA 115D between the terminal 115A and the terminal 115F during the reception.

During the transmission, the connection switching unit 115 amplifies a signal level (intensity) of a signal input from the mixer 120 to a predetermined signal level with the PA 115C and outputs the signal to the antenna element 110. During the reception, the connection switching unit 115 amplifies a signal input from the antenna element 110 with the LNA 115D and outputs the signal to the mixer 120. The PA 115C and the LNA 115D are examples of an amplifying unit.

Twenty-five mixers 120 are installed corresponding to the twenty-five antenna elements 110. One terminal of the mixer 120 is connected to the other terminals of the distributor 130 and the distributor 160. The other terminal of the mixer 120 is connected to the connection switching unit 115. The mixer 120 is an example of a multiplier.

The lengths of signal paths from the twenty-five mixers 120 to the twenty-five connection switching units 115 are set to an equal length. The lengths of signal paths from the twenty-five connection switching units 115 to the twenty-five antenna elements 110 are set to an equal length. That is, for example, the lengths of the signal paths from the twenty-five mixers 120 to the twenty-five antenna elements 110 are aligned and set to an equal length.

During the transmission, the mixer 120 multiplies together a signal input from the distributor 130 and a signal input from the distributor 160 and outputs a multiplied signal to the connection switching unit 115. During the reception, the mixer 120 multiplies together a signal input from the connection switching unit 115 and a signal input from the distributor 160 and outputs a multiplied signal to the distributor 130.

The twenty-five antenna elements 110, the twenty-five connection switching units 115, and the twenty-five mixers 120 are installed as explained above. One connection switching unit 115 and one mixer 120 are connected to one antenna element 110.

A set including one antenna element 110, one connection switching unit 115, and one mixer 120 is disposed on the inside of a disposition region 10A in a plan view. In FIG. 1, only the disposition region 10A corresponding to one antenna element 110 on the most negative direction side in the X-axis direction and the most positive direction side in the Y-axis direction is illustrated. However, the disposition region 10A is installed by a number equal to the number of sets of the antenna elements 110, the connection switching units 115, and the mixers 120. That is, for example, twenty-five disposition regions 10A in five rows and five columns are installed in a matrix shape. One set of the twenty-five antenna elements 110, the twenty-five connection switching units 115, and the twenty-five mixers 120 is disposed in each of the disposition regions 10A.

As explained above, the length in the X-axis direction and the Y-axis direction of the antenna element 110 is ½ (λ/2) of the electric length λ of the wavelength of the communication frequency. The interval in the X-axis direction and the Y-axis direction between the antenna elements 110 adjacent to each other is ½ (λ/2) of the electric length λ of the wavelength in the communication frequency. Therefore, the disposition regions 10A adjacent to each other are disposed close to each other.

In the disposition region 10A, the antenna element 110, the connection switching unit 115, and the mixer 120 are connected by a via piercing through the insulating layers of the substrate 10 and a wire. Therefore, the connection switching unit 115 and the mixer 120 may be disposed close to the antenna element 110.

The connection switching unit 115 and the mixer 120 may be disposed to overlap the antenna element 110 in a plan view on the inside of the disposition region 10A. Only one of the connection switching unit 115 and the mixer 120 may be disposed to overlap the antenna element 110 in a plan view on the inside of the disposition region 10A. Only parts of the connection switching unit 115 and the mixer 120 or only a part of one of the connection switching unit 115 and the mixer 120 may be disposed to overlap the antenna element 110 in a plan view on the inside of the disposition region 10A. The connection switching unit 115 and the mixer 120 may be disposed not to overlap the antenna element 110 in a plan view. Which disposition is adopted only has to be determined considering a radiation characteristic of the antenna element 110, a relation of the sizes of the antenna element 110, the connection switching unit 115, and the mixer 120 with respect to the size of the disposition region 10A, or the like.

Five distributors 130 are installed corresponding to the five groups in the column direction of the antenna elements 110. The distributor 130 is an example of a third distributor. One terminals of the five distributors 130 are respectively connected to the other terminals of the five phase shifters 140.

The other terminals of the five distributors 130 are respectively connected to the five antenna elements 110 included in the five groups in the column direction. That is, for example, the other terminal of the distributor 130 illustrated on the most negative direction side in the X-axis direction is connected to the five antenna elements 110 included in a group in the column direction located on the most negative direction side in the X-axis direction. The other terminals of the distributors 130 illustrated second, third, fourth, and fifth from the most negative direction ide in the X-axis direction are respectively connected to the five antenna elements 110 included in groups in the column direction located second, third, fourth, and fifth from the most negative direction side in the X-axis direction.

During the transmission of the transceiver 100, the five distributors 130 respectively distribute signals, to which predetermined phases are given by the five phase shifters 140, to the five antenna elements 110 included in groups in the column direction corresponding to the five distributors 130.

During the reception of the transceiver 100, the five distributors 130 multiply together signals input from the five antenna elements 110 included in the groups in the column direction corresponding to the five distributors 130 and respectively output multiplied signals to the five phase shifters 140.

The five phase shifters 140 are installed corresponding to the five groups in the column direction of the antenna elements 110. In other words, for example, the five phase shifters 140 are installed corresponding to the five distributors 130. The phase shifter 140 is an example of a first phase shifter.

One terminals of the five phase shifters 140 are respectively connected to the five distributors 130. The other terminals of the five phase shifters 140 are connected to one distributor 151. Phase control terminals of the five phase shifters 140 are connected to the DAC 155.

During the transmission of the transceiver 100, the five phase shifters 140 respectively give phases set by the DAC 155 to signals input from the distributor 151 and output the signals to the five distributors 130. For example, when both of the azimuth angle and the elevation angle are set to 30°, the phases given to the input signals by the five phase shifters 140 are respectively set to 0°, 45°, 90°, 135°, and 180° by the DAC 155.

During the reception of the transceiver 100, the five phase shifters 140 respectively give phases set by the DAC 155 to signals input from the five distributors 130 and output the signals to the distributor 151.

The distributor 151 is connected between the five phase shifters 140 and the switch 152. The distributor 151 is an example of a first distributor. During the transmission of the transceiver 100, the distributor 151 distributes a signal input from the switch 152 to the five phase shifters 140. During the reception of the transceiver 100, the distributor 151 multiplies together signals input from the five phase shifters 140 and outputs a multiplied signal to the switch 152.

The switch 152 is a switch of a three-terminal type and is connected among the distributor 151, the DAC 153, and the ADC 154. The switch 152 is an example of a changeover switch. During the transmission of the transceiver 100, the switch 152 connects the distributor 151 and the DAC 153. During the reception of the transceiver 100, the switch 152 connects the distributor 151 and the ADC 154. The switching of the switch 152 is performed by a control unit 195 of the control device 190.

The DAC 153 is connected between the switch 152 and the control device 190. During the transmission of the transceiver 100, the DAC 153 converts a signal (a transmission signal) in a digital format input from the control device 190 into a transmission signal of an analog format and outputs the signal to the switch 152.

During the reception of the transceiver 100, the ADC 154 converts a signal (a reception signal) of an analog format input from the switch 152 into a reception signal of a digital format and outputs the reception signal to the control device 190.

The DAC 155 is connected between the phase control terminals of the five phase shifters 140 and the control device 190. The DAC 155 converts a phase control signal of a digital format input from the control device 190 into a phase control signal of an analog format and outputs the phase control signal to the phase control terminals of the five phase shifters 140. Five phase control signals of the digital format input from the control device 190 to the DAC 155 are present corresponding to the five phase shifters 140.

Five distributors 160 are installed corresponding to the five groups in the row direction of the antenna elements 110. The distributor 160 is an example of a fourth distributor. One terminals of the five distributors 160 are respectively connected to one terminals of the five phase shifters 170.

The other terminals of the five distributors 160 are respectively connected to the five antenna elements 110 included in the five groups in the row direction. That is, for example, the other terminal of the distributor 160 illustrated on the most negative direction side in the Y-axis direction is connected to the five antenna elements 110 included in a group in the row direction located on the most negative direction side in the Y-axis direction. The other terminals of the distributors 160 illustrated second, third, fourth, and fifth from the most negative direction side in the Y-axis direction are respectively connected to the five antenna elements 110 included in the groups in the row direction located second, third, fourth, and fifth from the most negative direction side in the Y-axis direction.

During the transmission of the transceiver 100, the five distributors 160 respectively distribute signals, to which predetermined phases are given by the five phase shifters 170, to the five antenna elements 110 included in the groups in the row direction corresponding to the five distributors 160.

During the reception of the transceiver 100, the five distributors 160 multiply together signals input from the five antenna elements 110 included in the groups in the row direction corresponding to the five distributors 160 and respectively output multiplied signals to the five phase shifters 170.

The five phase shifters 170 are installed corresponding to the five groups in the row direction of the antenna element 110. In other words, for example, the five phase shifters 170 are installed corresponding to the five distributors 160. The phase shifter 170 is an example of a second phase shifter.

One terminals of the five phase shifters 170 are respectively connected to the five distributors 160. The other terminals of the five phase shifters 170 are connected to one distributor 181. Phase control terminals of the five phase shifters 170 are connected to the DAC 183.

During the transmission of the transceiver 100, the five phase shifters 170 respectively give phases set by the DAC 183 to signals input from the distributor 181 and output the signals to the five distributors 160. For example, when both of the azimuth angle and the elevation angle are set to 30°, the phases given to the input signals by the five phase shifters 170 are respectively set to 0°, 78°, 156°, 234°, and 312° by the DAC 183.

During the reception of the transceiver 100, the five phase shifters 170 respectively give phases set by the DAC 183 to signals input from the five distributors 160 and output the signals to the distributor 181.

The distributor 181 is connected between the five phase shifters 170 and the local signal generator 182. The distributor 181 is an example of a second distributor. During the transmission and the reception of the transceiver 100, the distributor 181 distributes a local signal input from the local signal generator 182 to the five phase shifters 170.

The local signal generator 182 is a signal generation source that generates a local signal (a carrier wave signal). A frequency of the local signal is lower than the communication frequency.

The DAC 183 is connected between the phase control terminals of the five phase shifters 170 and the control device 190. The DAC 183 converts a phase control signal of a digital format input from the control device 190 into a phase control signal of an analog format and outputs the phase control signal to the phase control terminals of the five phase shifters 170. Five phase control signals of the digital format input from the control device 190 to the DAC 183 are present corresponding to the five phase shifters 170.

The control device 190 includes a modulating unit 191, a transmission-data processing unit 192, a demodulating unit 193, a reception-data processing unit 194, a control unit 195, and a memory 196. The control device 190 is realized by a computer including a central processing unit (CPU), a random access memory (RAM), a read only memory (ROM), a hard disk drive (HDD), an input and output interface, and an internal bus.

The modulating unit 191, the transmission-data processing unit 192, the demodulating unit 193, the reception-data processing unit 194, and the control unit 195 are illustration as functional blocks of functions of computer programs executed by the control device 190. The memory 196 is functional representation of a memory of the control device 190.

The modulating unit 191 modulates transmission data of a digital format input from the transmission-data processing unit 192 and outputs the transmission data to the DAC 153. The transmission-data processing unit 192 performs digital signal processing on transmission data input from the control unit 195 and outputs the transmission data to the modulating unit 191 as a baseband signal. The transmission-data processing unit 192 is an example of a transmission circuit.

The demodulating unit 193 demodulates a reception signal of a digital format input from the ADC 154 and outputs the reception signal to the reception-data processing unit 194. The reception-data processing unit 194 performs digital signal processing on the reception signal and outputs the reception signal to the control unit 195 as reception data. The reception-data processing unit 194 is an example of a reception circuit.

The control unit 195 is connected to a computer such as a server. The control unit 195 receives an input of transmission data from the server and performs data processing for outputting reception data to the server. The control unit 195 refers to a phase difference database stored in the memory 196 and outputs phase data to the DACs 155 and 183 in order to set shift amounts of phases in the phase shifters 140 and 170.

The memory 196 stores the phase difference database used when the shift amounts of the phases of the phase shifters 140 and 170 are set. The phase difference database is a data of a table format and is a lookup table.

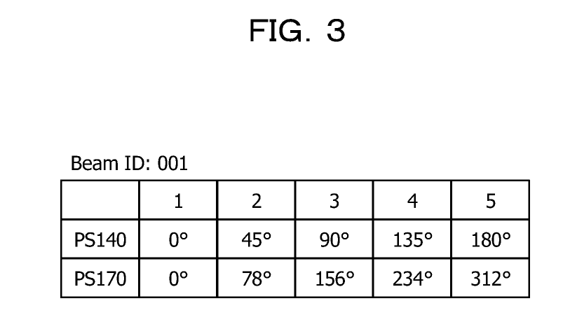

FIG. 3 is a diagram illustrating a data structure of the phase difference database. The phase difference database is a data of a table format and is a lookup table in which data (phase data) representing phases set in the five phase shifters (PSs) 140 and the five phase shifters (PSs) 170 are associated for each of beam identifiers (IDs).

Values of 1 to 5 in a first row of the phase difference database are identification values used for identification of the five phase shifters 140 and the five phase shifters 170. The identification values of 1 to 5 are allocated to the five phase shifters 140 from the X-axis negative direction side to the X-axis positive direction side. That is, for example, an identification value allocated to the phase shifter 140 located on the most negative direction side in the X-axis direction is 1. An identification value allocated to the phase shifter 140 located on the most positive direction side in the X-axis direction is 5.

Similarly, identification values of 1 to 5 are allocated to the five phase shifters 170 from the Y-axis negative direction side to the Y-axis positive direction side. That is, for example, an identification value allocated to the phase shifter 170 located on the most negative direction side in the Y-axis direction is 1. An identification value allocated to the phase shifter 170 located on the most positive direction side in the Y-axis direction is 5.

The transceiver 100 has a plurality of beam IDs in order to make it possible to irradiate beams in directions determined by various azimuth angles and elevation angles. In order to differentiate an irradiation direction of a beam for each of the beam IDs, five phases set in each of the phase shifters 140 and 170 included in the phase difference database are set to values (ten values) of a combination different for each of the beam IDs. Beams radiated by the transceiver 100 include data representing the beam IDs.

In FIG. 3, as an example, a phase difference database in which both of the azimuth angle (phi) and the elevation angle (theta) are 30° is illustrated. A beam ID of this phase difference database is 001. In the phase difference database having the beam ID of 001, 0°, 45°, 90°, 135°, and 180° are respectively allocated to the phase shifters 140 having the identification values of 1 to 5 and 0°, 78°, 156°, 234°, and 312° are respectively allocated to the phase shifters 170 having the identification values of 1 to 5.

As an example, the transceiver 100 includes sixty-four kinds of phase difference databases. Peculiar beam IDs are respectively allocated to the sixty-four kinds of phase difference databases.

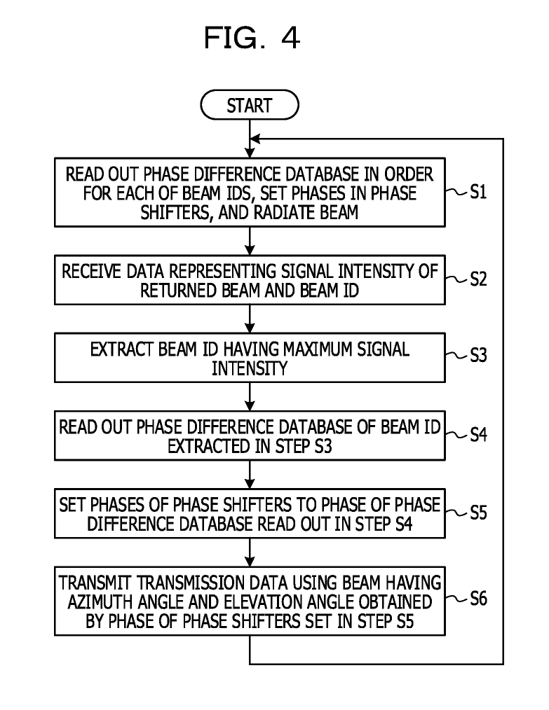

FIG. 4 is a flowchart illustrating processing executed by the control unit 195 of the control device 190. As preconditions, a terminal machine that receives a beam radiated from the transceiver 100 is present and, when receiving a beam and a beam ID, the terminal machine returns data representing signal intensity of the beam and the beam ID.

When starting the processing, the control unit 195 reads out, in the order of the beam IDs, the phase difference database stored in the memory 196, sets phases in the phase shifters 140 and 170, and radiates beams (step S1). Data of beam IDs is included in the beams radiated by the transceiver 100.

In the processing in step S1, the control unit 195 sets, in order, phases of the phase shifters 140 and 170 to phases determined by phase difference databases having all the beam IDs and radiates beams. That is, for example, in the processing in step S1, beams are radiated by the number of times same as the number of beam IDs. Combinations of azimuth angles and elevation angles of the beams are different from one another.

Subsequently, the control unit 195 receives data representing signal intensity of a beam and a beam ID returned from the terminal machine (step S2). In step S2, the control unit 195 receives data representing signal intensity of beams and beam IDs by the number of times same as the number of beam IDs.

Subsequently, the control unit 195 extracts a beam ID having maximum signal intensity among the data representing the signal intensity of the beams and the beam IDs received in step S2 (step S3).

Subsequently, the control unit 195 reads out a phase difference database having the beam ID extracted in step S3 (step S4).

Subsequently, the control unit 195 sets phases of the phase shifters 140 and 170 to a phase of the phase difference database read out in step S4 (step S5). That is, for example, according to the processing in step S5, the phases of the phase shifters 140 and 170 are adjusted to a phase for realizing an azimuth angle and an elevation angle of a beam having the highest signal intensity of a reception signal. In this way, an adjusting method for phases in the transceiver 100 is executed.

Subsequently, the control unit 195 transmits transmission data using a beam having an azimuth angle and an elevation angle obtained by the phases of the phase shifters 140 and 170 set in step S5 (step S6).

The control unit 195 repeatedly executes the processing in steps S1 to S6 while a power supply of the transceiver 100 is on. When the power supply of the transceiver 100 is turned off, the control unit 195 ends a series of processing. The operation in transmitting transmission data is explained above. However, when a reception signal is received, the reception signal only has to be received in step S6.

An antenna weight w (setting values of phases of the phase shifters 140 and 170) for realizing a direction of a beam is explained.

When the number of the antenna elements 110 in the X-axis direction is represented as M (M is an integer equal to or larger than 2), the number of the antenna elements 110 in the Y-axis direction is represented as N (N is an integer equal to or larger than 2), an azimuth angle of a beam is represented as ϕ, and an elevation angle of the beam is represented as θ, the antenna weight w for realizing the direction of the beam may be calculated by the following Expression (1).

In Expression (1), m represents any integer satisfying m=1 is allocated to the phase shifter 140 connected to the antenna element 110 of the group in the column direction located on the most negative direction side in the X-axis direction and a value of m increases by 1 every time the phase shifter 140 shifts in the X-axis positive direction. Therefore, m=M in the phase shifter 140 connected to the antenna element 110 of a group in the column direction located on the most positive direction side in the X-axis direction.

Similarly, n represents any integer satisfying 1≤n≤N, n=1 is allocated to the phase shifter 170 connected to the antenna element 110 of the group in the row direction located on the most negative direction side in the Y-axis direction and a value of n increases by 1 every time the phase shifter 140 shifts in the Y-axis positive direction. Therefore, n=N in the phase shifter 140 connected to the antenna element 110 of a group in the row direction located on the most positive direction side in the Y-axis direction.

$$\begin{matrix}w = {e}^{j π ( msin θ cos φ + nsin θ sin φ )} \\ = {e}^{j π ( msin θ cos φ )} \times {e}^{j π ( nsin θ sin φ )}\end{matrix} \qquad ( 1 )$$

From Expression (1), a phase set in the phase shifter 140 may be calculated by the following Expression (2).

$$α = {tan}^{- 1} \frac{sin ( m πsinθcosφ )}{cos ( m πsinθcosφ )} \qquad ( 2 )$$

In Expression (2), by substituting values in m, it is possible to calculate values of phases in the phase shifters 140 connected to the antenna elements 110 of the group in the column direction.

From Expression (1), a phase set in the phase shifter 170 may be calculated by the following Expression (3).

$$β = {tan}^{- 1} \frac{sin ( n πsinθsinφ )}{cos ( n πsinθsinφ )} \qquad ( 3 )$$

In Expression (3), by substituting values in n, it is possible to calculate values of phases in the phase shifters 170 connected to the antenna elements 110 of the group in the row direction.

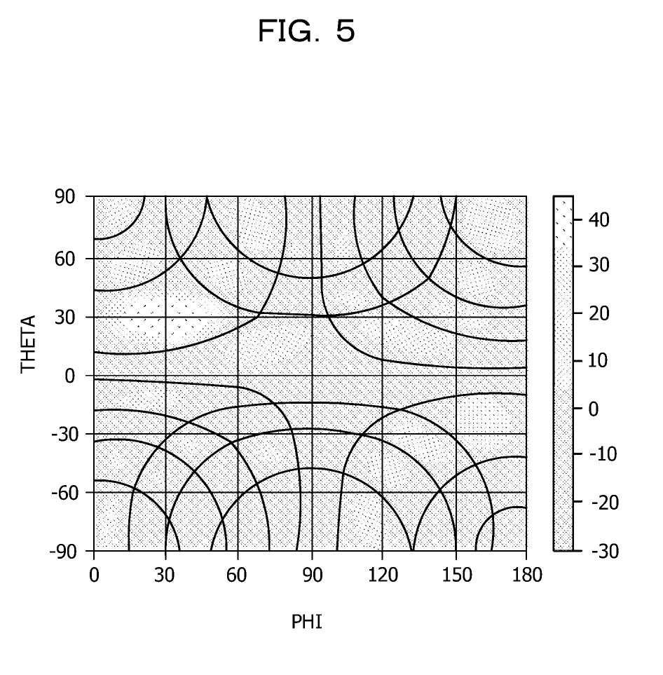

FIG. 5 is a diagram illustrating a simulation result of signal levels in a far field at the time when the transceiver 100 irradiates a beam. A distribution of signal levels illustrated in FIG. 5 is calculated by an electromagnetic field simulation.

In FIG. 5, the horizontal axis indicates an azimuth angle (phi) and the vertical axis indicates an elevation angle (theta). A direction in which the azimuth angle (phi) is 90° and the elevation angle (theta) is 0° is a direction of the Z axis passing the center of the antenna element 110 at 246° located in the center of the twenty-five antenna elements 110.

In FIG. 5, a paler color (white) indicates that a signal level indicated by a gray scale is higher and a darker color (black) indicates that the signal level is lower.

When phases of the phase shifters 140 and 170 were set based on the phase difference database illustrated in FIG. 3 in which both of the azimuth angle (phi) and the elevation angle (theta) were 30° and radiation was performed, as illustrated in FIG. 5, a beam was successfully radiated in a direction in which both of the azimuth angle (phi) and the elevation angle (theta) are 30°.

As explained above, according to the first embodiment, it is possible to radiate signals having different phases respectively from the twenty-five antenna elements 110 with a configuration including the five phase shifters 140 corresponding to the five groups in the column direction and the five phase shifter 170 corresponding to the five groups in the row direction.

Therefore, it is possible to provide the transceiver 100 having a simple configuration. Since the phase shifters 140 and 170 have a relatively large circuit size, it is possible to greatly reduce the circuit size compared with a configuration including phase shifters as many as antenna elements as in the transceiver in the past.

The transceiver 100 includes the connection switching units 115 and the mixers 120 by the same number (twenty-five) as the antenna elements 110. However, the connection switching units 115 and the mixers 120 have a small circuit size compared with the phase shifters 140 and 170. Therefore, in the first embodiment, it is possible to provide the transceiver 100, the circuit size of which is reduced more than the transceiver in the past and the configuration of which is simplified.

Pluralities of antenna elements 110 are arrayed in the row direction and the column direction. In this case, the length in the X-axis direction and the Y-axis direction of the antenna element is ½ (λ/2) of the electric length λ of the wavelength in the communication frequency. An interval in the X-axis direction and the Y-axis direction between the antenna elements 110 adjacent to each other is ½ (λ/2) of the electric length λ of the wavelength in the communication frequency.

Therefore, it is possible to dispose the connection switching unit 115 and the mixer 120 close to the antenna element 110.

Phases allocated to the antenna elements 110 are set by the mixers 120 located close to the antenna elements 110. The lengths of the signal paths from the twenty-five mixers 120 to the twenty-five antenna elements 110 are aligned.

Therefore, errors of phases set in the twenty-five antenna elements 110 are few. It is possible to suppress occurrence of delays of transmission signals or reception signals between the twenty-five antenna elements 110 and the twenty-five mixers 120. For example, as in the transceiver in the past, when phases in antenna elements are set by phase shifters as many as the antenna elements, errors of phases, delays of transmission signals or reception signals, or the like could occur among a plurality of antenna elements because of, for example, fluctuation in the lengths of signal paths between the antenna elements and the phase shifters.

On the other hand, the transceiver 100 may considerably reduce errors of phases set in the twenty-five antenna elements 110 and suppress occurrence of delays of transmission signals or reception signals. Therefore, a satisfactory communication characteristic may be obtained.

Since the number of the phase shifters 140 and 170 is small compared with the transceiver in the past, the transceiver 100 may reduce a time for setting phases in the phase shifters 140 and 170 and quickly perform switching of an angle of a beam.

The form in which the number of the antenna elements 110 is twenty-five in five columns and five rows is explained above. However, the number of the antenna elements 110 is not limited to twenty-five and may be, for example, sixty-four in eight columns and eight rows. The numbers of the antenna elements 110 in the X-axis direction and the Y-axis direction may be different. The array of the antenna elements 110 is not limited to the rectangular shape (a matrix shape). The antenna elements 110 may be disposed to be arrayed at equal intervals in a region having a circular shape, an elliptical shape, a rhombus shape, a polygonal shape having three or five or more sides.

When the plurality of antenna elements 110 are arrayed in a region having a shape other than the rectangular shape, the number of the antenna elements 110 disposed in the Y-axis direction (the column direction) on the center side in the X-axis direction and the number of the antenna elements 110 disposed in the Y-axis direction (the column direction) on the end portion side in the X-axis direction are different. The same applies to the Y-axis direction.

In such a case, the number of the phase shifters 140 only has to be set the same as a maximum of the number M of the antenna elements 110 disposed in the X-axis direction in the same row. The number of the phase shifters 170 only has to be set the same as a maximum of the number N of the antenna elements 110 disposed in the Y-axis direction in the same column.

In the form explained above, the antenna elements 110, the connection switching units 115, the mixers 120, the distributors 130, the phase shifters 140, the distributor 151, the switch 152, the DAC 153, the ADC 154, the DAC 155, the distributors 160, the phase shifters 170, the distributor 181, the local signal generator 182, the DAC 183, and the control device 190 are mounted on the substrate 10.

However, the antenna elements 110, the connection switching units 115, and the mixers 120 only have to be disposed on the substrate 10. In this case, the phase shifters 140, the distributor 151, the switch 152, the DAC 153, the ADC 154, the DAC 155, the distributors 160, the phase shifters 170, the distributor 181, the local signal generator 182, the DAC 183, and the control device 190 may be installed on the outside of the substrate 10.

The connection switching units 115 and the mixers 120 may be disposed on the outside of the substrate 10 if the lengths of the signal paths between all the antenna elements 110 and the mixers 120 may be aligned.

### Second Embodiment

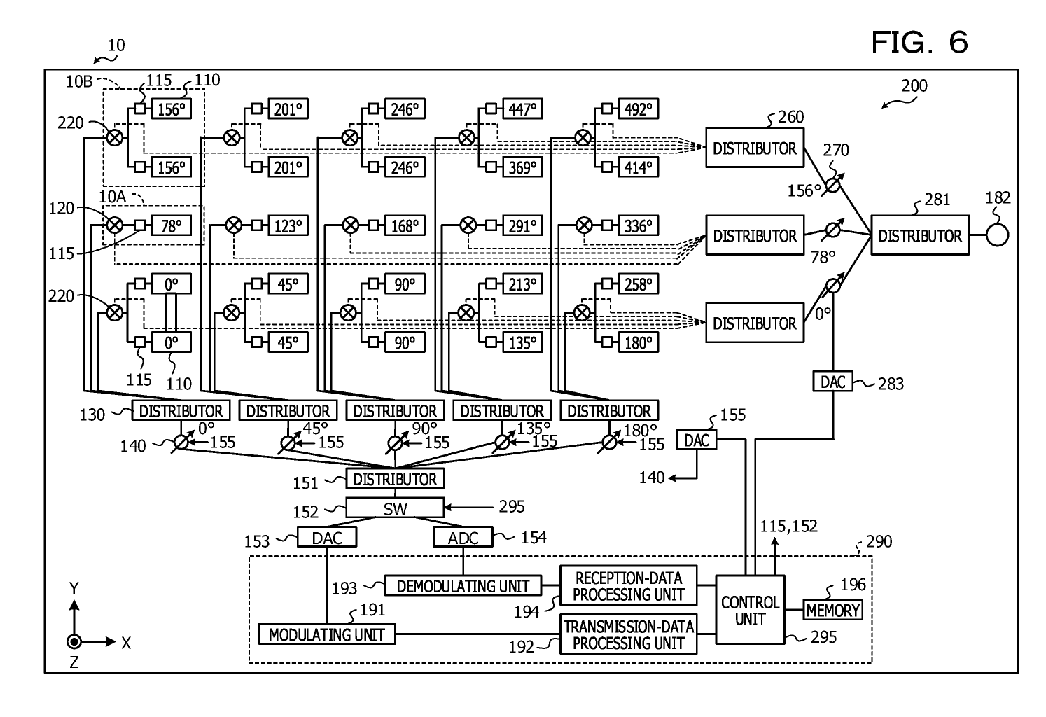

FIG. 6 is a diagram illustrating a transceiver 200 in a second embodiment. The same components as the components of the transceiver 100 in the first embodiment are denoted by the same reference numerals and signs. Explanation of the components is omitted.

The transceiver 200 includes the substrate 10, the antenna elements 110, the connection switching units 115, the mixers 120, mixers 220, the distributors 130, the phase shifters 140, the distributor 151, the switch 152, the DAC 153, the ADC 154, and the DAC 155.

The transceiver 200 further includes distributors 260, phase shifters 270, a distributor 281, the local signal generator 182, a DAC 283, and a control device 290. Wires connecting the mixers 120 and 220 and the distributors 260 are indicated by broken lines.

In the transceiver 200, the twenty-five antenna elements 110 and the twenty-five connection switching units 115 are provided. The five mixers 120 are provided and ten mixers 220 are provided. Three distributors 260 and three phase shifters 270 are provided.

The control device 290 includes the modulating unit 191, the transmission-data processing unit 192, the demodulating unit 193, the reception-data processing unit 194, a control unit 295, and the memory 196. The control device 290 is different from the control unit 195 of the control device 190 in the first embodiment in control processing performed by the control unit 295. The control unit 295 is different from the control unit 195 in the first embodiment in that the control unit 295 adjusts phases of the five phase shifters 140 and the three phase shifters 270.

In the transceiver 200, the antenna elements 110 included in a group in a first row and the antenna elements 110 included in a group in a second row are connected to common mixers 220. Five mixers 220 are allocated to the groups in the first row and the second row. Two antenna elements 110 in the same column are connected to the common mixer 220 via two connection switching units 115 connected to the two antenna elements 110.

The antenna elements 110 included in a group in a fourth row and the antenna elements 110 included in a group in a fifth row are connected to the common mixers 220. The five mixers 220 are allocated to the groups in the fourth row and the fifth row. Two antenna elements 110 in the same column are connected to the common mixer 220 via the two connection switching units 115 connected to the two antenna elements 110.

In a group in a third row, as in the first embodiment, the five antenna elements 110 are respectively connected to the five mixers 120 via the five connection switching units 115.

One terminals of the three distributors 260 are respectively connected to the five mixers 220 connected to the antenna elements 110 in the first row and the second row, the five mixers 120 connected to the antenna elements 110 in the third row, and the five mixers 220 connected to the antenna elements 110 in the fourth row and the fifth row.

The other terminal of the distributor 260 connected to the mixers 220 corresponding to the first row and the second row, the other terminal of the distributor 260 connected to the mixers 120 corresponding to the third row, and the other terminal of the distributor 260 connected to the mixers 220 corresponding to the fourth row and the fifth row are respectively connected to the three phase shifters 270.

The three phase shifters 270 are connected to the local signal generator 182 via the distributor 281.

The twenty-five antenna elements 110 in the five rows may be grasped as being obtained by adding ten antenna elements 110 in the second row and the fourth row to fifteen antenna elements 110 in the first row, the third row, and the fifth row connected to the mixers 220 in the three rows.

In this case, the fifteen antenna elements 110 in the first row, the third row, and the fifth row are an example of a first antenna element. The ten antenna elements 110 in the second row and the fourth row are an example of a second antenna element. The fifteen antenna elements 110 in the second row, the third row, and the fourth row may be grasped as an example of the first antenna element. The ten antenna elements 110 in the first row and the fifth row may be grasped as an example of the second antenna element.

In such a transceiver 200, as illustrated in FIG. 6 as an example, the control device 290 sets phases of 0°, 45°, 90°, 135°, and 180° in the five phase shifters 140 and sets phases of 0°, 78°, and 156° in the three phase shifters 270.

In this case, it is possible to allocate phase differences of 0°, 45°, 90°, 135°, 180°, 0°, 45°, 90°, 135°, 180°, 78°, 123°, 168°, 213°, 258°, 156°, 201°, 246°, 291°, 336°, 156°, 201°, 246°, 291°, and 336° may be allocated to the twenty-five antenna elements 110.

When an azimuth angle and an elevation angle of a beam irradiated by the transceiver 200 are changed, phases set in the five phase shifters 140 and the three phase shifters 270 only have to be changed.

According to the second embodiment, the number of the phase shifters 270 and the distributors 260, which adjust the elevation angle of the beam, is reduced to three. The mixers 220 connected to the antenna elements 110 in the first row and the second row and the antenna elements 110 in the fourth row and the fifth row are used in common. Therefore, it is possible to further simplify the configuration of the transceiver 200.

Compared with the transceiver 100 in the first embodiment, the adjustment of the elevation angle is rough. However, in a use without hindrance in communication, it is possible to provide the transceiver 200 in which components are reduced to simplify the configuration.

The transceiver 200 in which the number of the distributors 260, which adjust the elevation angle of the beam, is reduced to three compared with the transceiver 100 in the first embodiment is explained. However, the number of the phase shifters 140 and the distributors 130, which adjust the azimuth angle of the beam, may be reduced.

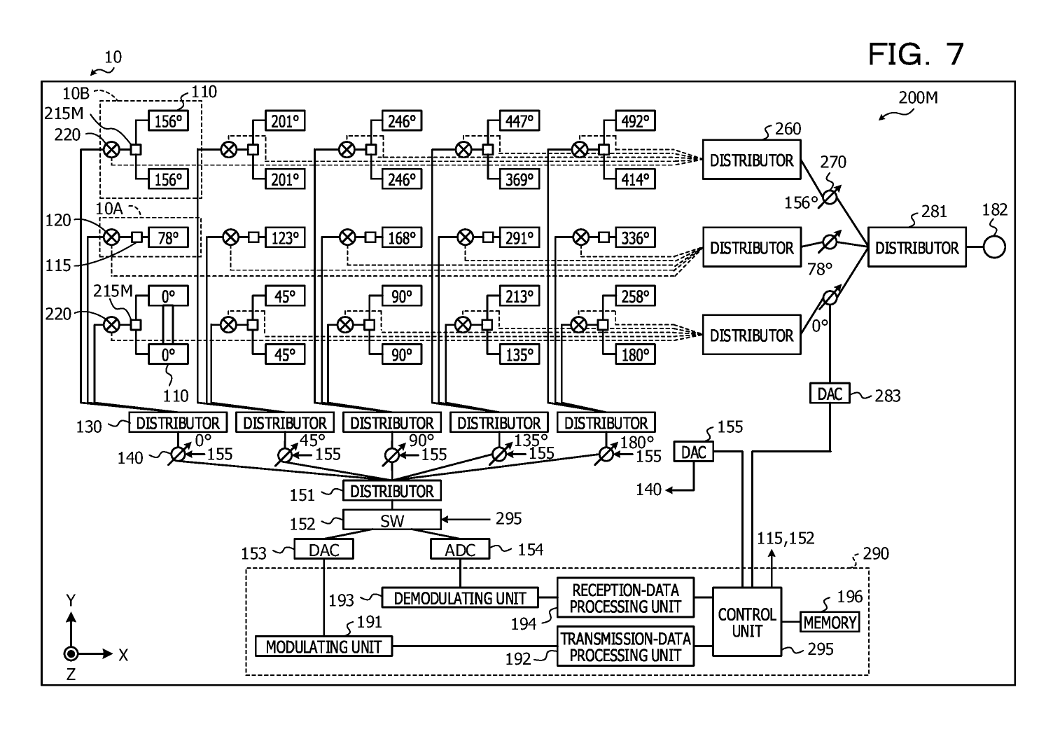

Like a transceiver 200M in a modification of the second embodiment illustrated in FIG. 7, a configuration including common connection switching units 215M in the antenna elements 110 in the first row and the second row and the common connection switching units 215M in the antenna elements 110 in the fourth row and the fifth row may be adopted. FIG. 7 is a diagram illustrating the transceiver 200M in the modification of the second embodiment.

The transceiver 200M has a configuration in which the ten connection switching units 115 connected to the antenna elements 110 in the first row and the second row of the transceiver 200 illustrated in FIG. 6 are replaced with five connection switching units 215M common to the first row and the second row and the ten connection switching units 115 connected to the antenna elements 110 in the fourth row and the fifth row are replaced with the five connection switching units 215M common to the fourth row and the fifth row.

In the group in the third row, as in the first and second embodiments, the five antenna elements 110 are respectively connected to the five mixers 120 via the fifth connection switching units 115.

As explained above, according to the modification of the second embodiment, it is possible to further simplify the configuration by reducing the number of the connection switching units 215M.

It is possible to reduce the numbers of the PAs and the LNAs included in the connection switching units 215M by reducing the number of the connection switching units 215M. Therefore, it is possible to achieve a reduction in power consumption.

### Third Embodiment

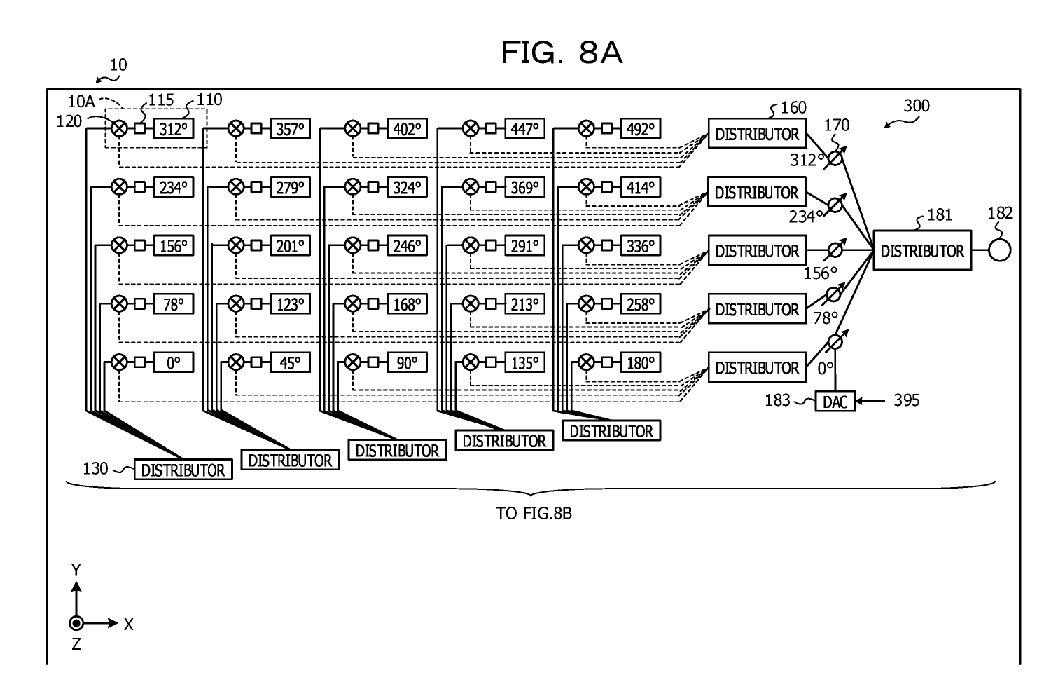

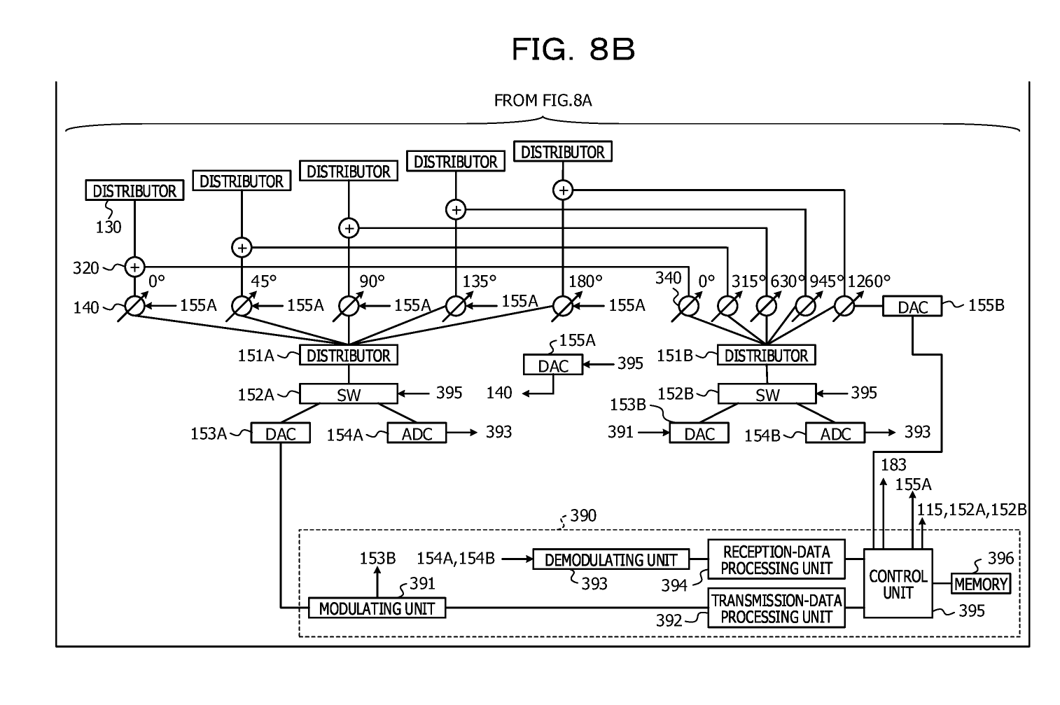

FIG. 8 is a diagram illustrating a transceiver 300 in a third embodiment. The same components as the components of the transceiver 100 in the first embodiment are denoted by the same reference numerals and signs. Explanation of the components is omitted.

The transceiver 300 includes the substrate 10, the antenna elements 110, the connection switching units 115, the mixers 120 and 220, the distributors 130, adders 320, phase shifters 140 and 340, distributors 151A and 151B, switches 152A and 152B, DACs 153A and 153B, ADCs 154A and 154B, and DACs 155A and 155B.

The transceiver 300 further includes the distributors 160, the phase shifters 170, a distributor 281, the local signal generator 182, the DAC 183, and a control device 390.

The control device 390 includes a modulating unit 391, a transmission-data processing unit 392, a demodulating unit 393, a reception-data processing unit 394, a control unit 395, and a memory 396.

The distributor 151A, the switch 152A, the DAC 153A, the ADC 154A, and the DAC 155A are respectively the same as the distributor 151, the switch 152, the DAC 153, the ADC 154, and the DAC 155 illustrated in FIG. 1.

The transceiver 300 has a configuration in which the adders 320, the phase shifters 340, the distributor 151B, the switch 152B, the DAC 153B, the ADC 154B, and the DAC 155B are added to the transceiver 100 (see FIG. 1) in the first embodiment and the control device 190 is replaced with the control device 390. The distributor 151B is an example of a sixth distributor.

Five adders 320 are installed. The five adders 320 are respectively connected among the five distributors 130, the five phase shifters 140, and five phase shifters 340.

During transmission, the adder 320 adds up a signal input from the phase shifter 140 and a signal input from the phase shifter 340 and outputs an added-up signal to the distributor 130. During reception, the adder 320 outputs a signal input from the distributor 130 dividedly to the phase shifter 140 and the phase shifter 340. During the reception, since the phase shifters 140 and 170 are present on the output side of the adder 320, the adder 320 divides a reception signal input from the distributor 130 into a reception signal corresponding to a phase of the phase shifter 140 and a reception signal corresponding to a phase of the phase shifter 340 and outputs the reception signals.

Like the phase shifters 140, the five phase shifters 340 are installed corresponding to the five groups in the column direction of the antenna elements 110. Phases given to signals by the five phase shifters 340 are set by phase control signals input from the DAC 155B to phase control terminals.

The five phase shifters 340 are connected between the five adders 320 and one distributor 151B. During the transmission, the phase shifters 340 respectively give phases to transmission signals input from the distributor 151B and output the transmission signals to the five adders 320. During the reception, the phase shifters 340 respectively give phases to reception signals input from the five adders 320 and output the reception signals to the distributor 151B.

In FIG. 8, as an example, a state is illustrated in which the five phase shifters 340 give phases of 0°, 315°, 630°, 945°, and 1260° to the antenna elements 110 included in the group in the first column to the antenna elements 110 included in the group in the fifth column.

The distributor 151B, the switch 152B, the DAC 153B, the ADC 154B, and the DAC 155B are respectively the same as the distributor 151A, the switch 152A, the DAC 153A, the ADC 154A, and the DAC 155A.

The distributor 151B, the switch 152B, the DAC 153B, the ADC 154B, and the DAC 155B are installed in parallel to the distributor 151A, the switch 152A, the DAC 153A, the ADC 154A, and the DAC 155A with respect to the control device 390.

The control device 390 includes a modulating unit 391, a transmission-data processing unit 392, a demodulating unit 393, a reception-data processing unit 394, a control unit 395, and a memory 396. The modulating unit 391, the transmission-data processing unit 392, the demodulating unit 393, the reception-data processing unit 394, the control unit 395, and the memory 396 are respectively basically the same as the modulating unit 191, the transmission-data processing unit 192, the demodulating unit 193, the reception-data processing unit 194, the control unit 195, and the memory 196.

However, the modulating unit 391, the transmission-data processing unit 392, the demodulating unit 393, the reception-data processing unit 394, the control unit 395, and the memory 396 are different in that the modulating unit 391, the transmission-data processing unit 392, the demodulating unit 393, the reception-data processing unit 394, the control unit 395, and the memory 396 perform processing of transmission data and reception data via two systems, that is, for example, a system including the phase shifters 140 and a system including the phase shifters 340.

The transceiver 300 in the third embodiment has a configuration corresponding to the two systems explained above. Therefore, the transceiver 300 may perform communication with two terminal machines.

The modulating unit 391 modulates transmission data of a digital format input from the transmission-data processing unit 192 and outputs the transmission data to the DACs 153A and 1536. The transmission-data processing unit 392 performs digital signal processing on transmission data input from the control unit 395 and outputs the transmission data to the modulating unit 391 as a baseband signal.

The demodulating unit 393 respectively demodulates two reception signals of a digital format input from the ADCs 154A and 154B and outputs the reception signals to the reception-data processing unit 194. The reception-data processing unit 394 performs digital signal processing on the two reception signals and outputs the reception signals to the control unit 395 as two reception data.

Like the control unit 195 in the first embodiment, the control unit 395 is connected to a computer such as a server. The control unit 395 receives an input of transmission data from the server and performs processing for outputting reception data to the server. The control unit 395 refers to a phase difference database stored in the memory 396 and outputs phase data to the DACs 155A, 155B, and 183 in order to set shift amounts of phases in the phase shifters 140, 170, and 340.

The memory 396 stores the phase difference database used when the shift amounts of the phases in the phase shifters 140, 340, and 170 are set. The phase difference database is a data in a table format and is a lookup table.

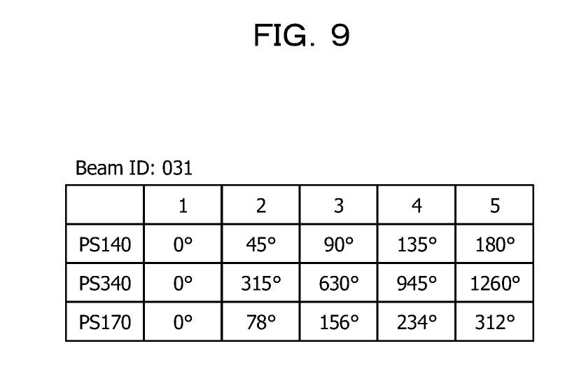

FIG. 9 is a diagram illustrating a data structure of a phase difference database in the third embodiment. The phase difference database is data in a table format and is a lookup table in which data (phase data) representing phases set in the five phase shifters (PSs) 140, the five phase shifters (PSs) 340, and the five phase shifters (PSs) 170 are associated for each of beam identifiers (IDs).

The phase difference database illustrated in FIG. 9 has a configuration in which the phase data of the five phase shifters (PSs) 340 is added to the phase difference database illustrated in FIG. 3. In the phase difference database having the beam ID of 031 illustrated in FIG. 9, phase data of 0°, 315°, 630°, 945°, and 1260° are respectively allocated to the phase shifters 340 having the identification values of 1 to 5.

If such a phase difference database is used, it is possible to set shift amounts of phases in the phase shifters 140, 170, and 340 in order to set azimuth angles and elevation angles of various beams.

During the transmission, the transceiver 300 having the configuration explained above adds up a transmission signal input from the modulating unit 391 via the DAC 153A, the SW 152A, the distributor 151A, and the phase shifter 140 and a transmission signal input from the modulating unit 391 via the DAC 153B, SW 152B, the distributor 151B, and the phase shifter 340.

Signals added up by the five adders 320 are respectively output to the twenty-five mixers 120 through the five distributors 130. The signal added up by the adder 320 is a multiple signal obtained by superimposing a signal to which a phase is given by the phase shifter 140 and a signal to which a phase is given by the phase shifter 340. Such superimposition of the signals may be realized because a local signal is common.

The twenty-five mixers 120 multiply together transmission signals input from the five distributors 130 and local signals input from the five distributors 160 and output multiplied signals to the twenty-five connection switching units 115. As a result, radio waves are radiated from the twenty-five antenna elements 110.

For example, when phases of the five phase shifters 140 are set to 0°, 45°, 90°, 135°, and 180°, phases of the five phase shifters 340 are set to 0°, 315°, 630°, 945°, and 1260°, and phases of the five phase shifters 170 are set to 0°, 78°, 156°, 234°, and 312°, the twenty-five antenna elements 110 radiate signals as follows.

Components passed through the phase shifters 140 among transmission signals input from the five distributors 130 and local signals input from the five distributors 160 are multiplied together, whereby the twenty-five antenna elements 110 respectively radiate signals having phases of 0°, 45°, 447°, and 492° as in the first embodiment.

Components passed through the phase shifters 340 among transmission signals input from the five distributors 130 and local signals input from the five distributors 160 are multiplied together, whereby the twenty-five antenna elements 110 respectively radiate twenty-five signals having the following phases. The phases of the twenty-five signals are 0°, 45°, 90°, 135°, 180°, 315°, 360°, 405°, 450°, 495°, 630°, 675°, 720°, 775°, 810°, 945°, 990°, 1035°, 1080°, 1125°, 1260°, 1305°, 1350°, 1395°, and 1440°.

On the other hand, during the reception, when the transceiver 300 receives signals from two terminal machines, the reception signals are input to the distributor 130 through the connection switching unit 115 and the mixer 120. In the distributor 130, the reception signals are divided into a component corresponding to a phase of the phase shifter 140 and a component corresponding to a phase of the phase shifter 340.

The component corresponding to the phase of the phase shifter 140 and the component corresponding to the phase of the phase shifter 340 are respectively input to the control unit 395 through the distributor 151A, the SW 152A, and the ADC 154A and the distributor 151B, the SW 152B, and the ADC 154B and further through the demodulating unit 393 and the reception-data processing unit 394. The control unit 395 performs data processing for outputting two reception data based on the reception signals from the two terminal machines to the server.

As explained above, according to the third embodiment, it is possible to perform communication with the two terminal machines with a configuration in which the adders 320, the phase shifters 340, the distributor 151B, the switch 152B, the DAC 153B, the ADC 154B, and the DAC 155B are added to the transceiver 100 (see FIG. 1) in the first embodiment and the control device 190 is replaced with the control device 390.

The transceiver 300 capable of communicating with the two terminal machines may radiate signals having different phases respectively from the twenty-five antenna elements 110 with a configuration including the five phase shifters 140 and the five phase shifters 340 corresponding to the five groups in the column direction and the five phase shifters 170 corresponding to the five groups in the row direction.

Therefore, it is possible to provide the transceiver 300 having a simple configuration. Since the phase shifters 140, 340, and 170 have a relatively large circuit size, it is possible to greatly reduce the circuit size compared with a configuration including phase shifters as many as antenna elements as in the transceiver in the past.

### Fourth Embodiment

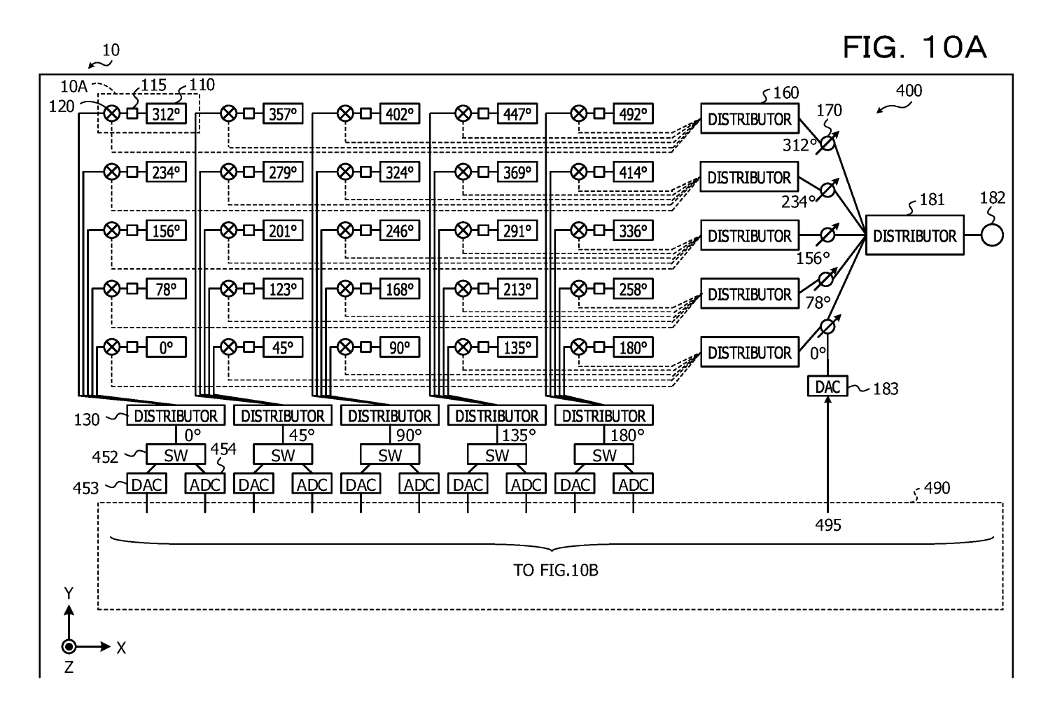

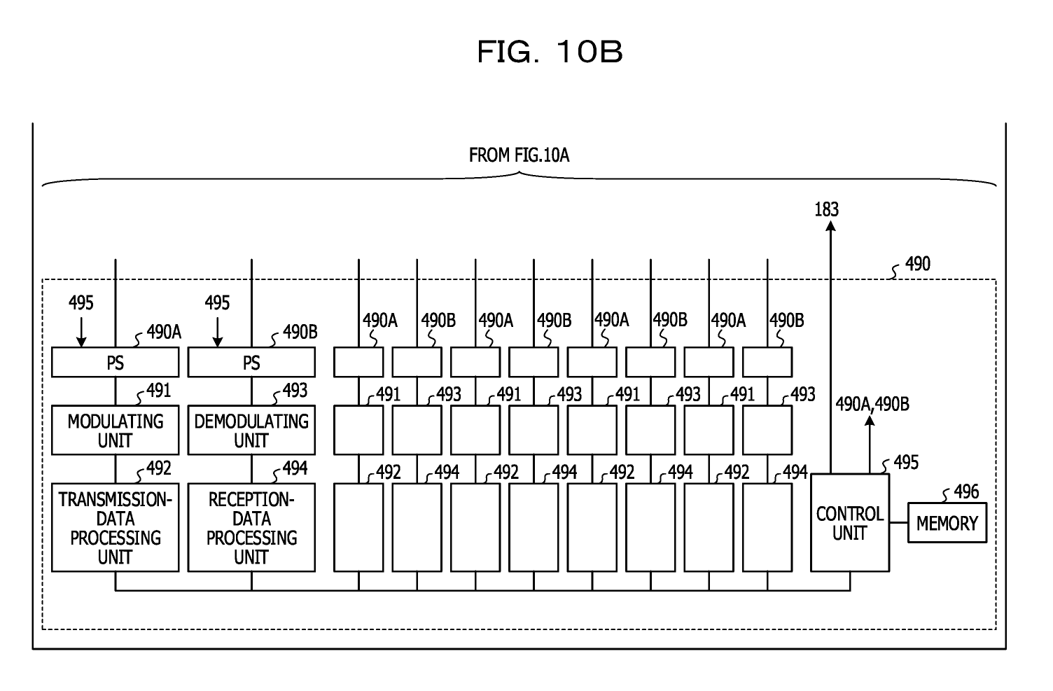

FIG. 10 is a diagram illustrating a transceiver 400 in a fourth embodiment. The same components as the components of the transceiver 100 in the first embodiment are denoted by the same reference numerals and signs. Explanation of the components is omitted.

The transceiver 400 includes the substrate 10, the antenna elements 110, the connection switching units 115, the mixers 120, the distributors 130, the distributors 160, the phase shifters 170, the distributor 181, the local signal generator 182, and the DAC 183.

The transceiver 400 further includes switches (SWs) 452, DACs 453, ADCs 454, and a control device 490.

The transceiver 400 has a configuration in which the control device 190 of the transceiver 100 in the first embodiment is replaced with the control device 490 and setting of phases in the X-axis direction is performed by digital signal processing. The control device 490 has the functions of the phase shifters 140 and the distributor 151 in the first embodiment.

Five switches 452, five DACs 453, and five ADCs 454 are installed respectively corresponding to the five groups in the column direction of the antenna elements 110. The switches 452, the DACs 453, and the ADCs 454 respectively correspond to the switch 152, the DAC 153, and the ADC 154 in the first embodiment. However, the switches 452 are directly connected to the distributors 130.

The DACs 453 and the ADCs 454 are connected to the control device 490. During transmission, the switches 452 connect the DACs 453 to the control device 490. During reception, the switches 452 connect the ADCs 454 to the control device 490.

The control device 490 includes phase shifters (PSs) 490A and 490B, modulating units 491, transmission-data processing units 492, demodulating units 493, reception-data processing units 494, a control unit 495, and a memory 496.

Five phase shifters 490A, five phase shifters 490B, five modulating units 491, five transmission-data processing units 492, five demodulating units 493, and five reception-data processing units 494 are installed corresponding to the five group in the column direction. The five transmission-data processing unit 492 and the five reception-data processing unit 494 are connected to the control unit 495.

The phase shifter 490A is a phase shifter for transmission. The phase shifter 490A performs phase setting in the X-axis direction based on a phase control signal input from the control unit 495. The phase shifter 490A corresponds to the function during the transmission of the phase shifter 140 in the first embodiment.

The phase shifter 490B is a phase shifter for reception. The phase shifter 490B performs phase setting in the X-axis direction based on a phase control signal input from the control unit 495. The phase shifter 490B corresponds to the function during the reception of the phase shifter 140 in the first embodiment.

The control unit 495 is connected to the five DACs 453 respectively via the five modulating units 491 and the five transmission-data processing units 492 and connected to the five ADCs 454 respectively via the five demodulating units 493 and the five reception-data processing units 494.

The control unit 495 refers to a phase difference database stored in the memory 496, sets a shift amount of a phase in the phase shifter 490A during the transmission, and sets a shift amount of a phase in the phase shifter 490B during the reception. At this time, the control unit 495 directly outputs digital values representing phases stored in the phase difference database to the PSs 490A and 490B. The PSs 490A and 490B shift phases of signals using the digital values representing the phases stored in the phase difference database. Therefore, as in the transceiver 100 in the first embodiment, it is possible to adjust an azimuth angle and an elevation angle of a beam.

As explained above, according to the fourth embodiment, by using the control device 490, it is possible to provide the transceiver 400 that digitally performs setting of phases in the X-axis direction. The transceiver 400 digitally performs the phase setting in the X-axis direction and does not use a phase shifter realized by an analog circuit component. Therefore, it is possible to simplify a configuration.

Since the transceiver 400 digitally performs the phase setting in the X-axis direction, for example, it is possible to provide the transceiver 400 having flexibility that may independently set the antenna weight w concerning the antenna elements 110 of the five groups in the column direction.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transceiver comprising:
a plurality of first antenna elements;
a first distributor that distributes a first data signal;
a second distributor that distributes a carrier wave signal;
a plurality of first phase shifters that shift phases of a plurality of the first data signals distributed by the first distributor;
a plurality of second phase shifters that shift phases of a plurality of the carrier wave signals distributed by the second distributor; and
a plurality of multipliers respectively connected to the plurality of first antenna elements, wherein
outputs of the plurality of first phase shifters and outputs of the plurality of second phase shifters are respectively connected to the plurality of multipliers.

2. The transceiver according to claim 1, wherein the plurality of first antenna elements are arrayed along a first axial direction and a second axial direction.

3. The transceiver according to claim 2, wherein
with respect to a number of pieces M (M is an integer equal to or larger than 2) of the first antenna elements disposed in the first axial direction and a number of pieces N (N is an integer equal to or larger than 2) of the first antenna elements disposed in the second axial direction,
the plurality of first antenna elements are divided into M first groups arranged in the first axial direction, positions in the first axial direction of the first groups being equal to one another, the first groups including the N first antenna elements arrayed along the second axial direction,
the transceiver further comprises:
M third distributors installed corresponding to the M first groups, the third distributors being connected to the N first antenna elements included in the first groups corresponding to the third distributors;
M first phase shifters respectively connected to the M third distributors; and
a changeover switch,
the first distributor is connected to the M first phase shifters, and
the changeover switch switches a connection destination of the first distributor to a transmission circuit or a reception circuit.

4. The transceiver according to claim 3, wherein
the plurality of first antenna elements are further divided into N second groups arranged in the second axial direction, positions in the second axial direction of the second groups being equal to one another, the second groups including the M first antenna elements arrayed along the first axial direction,
the transceiver further comprises:
N fourth distributors installed corresponding to the N second groups, the fourth distributors being connected to the M first antenna elements included in the second groups corresponding to the fourth distributors;
N second phase shifters respectively connected to the N fourth distributors; and
a carrier wave generator that generates the carrier wave signal,
the second distributor is connected to the N second phase shifters, and
the carrier wave generator is connected to the second distributor.

5. The transceiver according to claim 2, wherein
with respect to a maximum number of pieces M (M is an integer equal to or larger than 2) of the first antenna elements disposed in the first axial direction and a maximum number of pieces N (N is an integer equal to or larger than 2) of the first antenna elements disposed in the second axial direction,
the plurality of first antenna elements are divided into M first groups arranged in the first axial direction, positions in the first axial direction of the first groups being equal to one another, the first groups including N1 (2≤N1≤N) first antenna elements arrayed along the second axial direction,
the transceiver further comprises:
M third distributors installed corresponding to the M first groups, the third distributors being connected to the N1 first antenna elements included in the first groups corresponding to the third distributors;
M first phase shifters respectively connected to the M third distributors; and
a changeover switch,
the first distributor is connected to the M first phase shifters, and
the changeover switch switches a connection destination of the first distributor to a transmission circuit or a reception circuit.

6. The transceiver according to claim 5, wherein
the plurality of first antenna elements are further divided into N second groups arranged in the second axial direction, positions in the second axial direction of the second groups being equal to one another, the second groups including M1 (2≤M1≤M) first antenna elements arrayed along the first axial direction,
the transceiver further comprises:
N fourth distributors installed corresponding to the N second groups, the fourth distributors being connected to the M1 first antenna elements included in the second groups corresponding to the fourth distributors;
N second phase shifters respectively connected to the N fourth distributors; and
a carrier wave generator that generates the carrier wave signal,
the second distributor is connected to the N second phase shifters, and
the carrier wave generator is connected to the second distributor.

7. The transceiver according to claim 1, wherein
phases of the first phase shifter and the second phase shifter are variable, and
the transceiver further comprises a control unit that controls phases of the respective plurality of first phase shifters and the respective plurality of second phase shifters.

8. The transceiver according to claim 7, further comprising a memory connected to the plurality of first antenna elements via the plurality of multipliers, the memory storing a phase difference database in which phase differences of a plurality of transmission signals output to the plurality of first antenna elements via the plurality of multipliers or phase differences of a plurality of reception signals input from the plurality of first antenna elements via the plurality of multipliers and a phase difference of the carrier signal are associated, wherein
the control unit reads out the phase differences of the plurality of transmission signals or the plurality of reception signals and the phase difference of the carrier wave signal from the phase difference database stored in the memory and controls the phase differences.

9. The transceiver according to claim 1, further comprising a second antenna element connected to the multiplier.

10. The transceiver according to claim 1, further comprising a plurality of amplifying units respectively inserted into between the plurality of first antenna elements and the plurality of multipliers.

11. The transceiver according to claim 1, further comprising:
a plurality of amplifying units respectively inserted into between the plurality of first antenna elements and the plurality of multipliers; and
a second antenna element connected to the multiplier and the amplifier.

12. The transceiver according to claim 7, further comprising:
a sixth distributor that distributes a second data signal; and
a plurality of third phase shifters that shift phases of a plurality of the second data signals distributed by the sixth distributor, wherein
the control unit further controls phases of the respective plurality of third phase shifters.

13. An adjusting method for phases in a transceiver,
the transceiver including:
a plurality of first antenna elements;
a first distributor that distributes a first data signal;
a second distributor that distributes a carrier wave signal;
a plurality of first phase shifters that shift phases of a plurality of the first data signals distributed by the first distributor;
a plurality of second phase shifters that shift phases of a plurality of the carrier wave signals distributed by the second distributor; and
a plurality of multipliers respectively connected to the plurality of first antenna elements, wherein
outputs of the plurality of first phase shifters and outputs of the plurality of second phase shifters are respectively connected to the plurality of multipliers, and
a control unit controls phases of the respective plurality of first phase shifters and the respective plurality of second phase shifters.
